(19) United States
(12) Patent Application Publication
(10) Pub. No.: US 2010/0154496 A1
(43) Pub. Date: Jun. 24, 2010

(54) Binary sliding tumbler lock

(76) Inventor: Lewis A. Correia, Carlsbad, CA (US)

Correspondence Address: CALIF KIP TERVO, 6387 CAMINITO LAZARO, SAN DIEGO, CA, 92111, US

(21) Appl. No.: 12/317,559

(22) Filed: Dec. 23, 2008

(51) Int. Cl. E05B 37/12

(52) U.S. Cl. 70/292

(57) ABSTRACT

A low-profile, binary, sliding tumbler, user-settable combination lock of few parts can be easily and quickly opened, even in the dark. The lock generally comprises a stationary case or frame including a bottom plate, a middle plate and a top plate, a plurality of laterally sliding binary tumblers, and a longitudinally sliding bolt. The tumblers have a bearing portion sandwiched for lateral sliding movement between the top plate and the middle plate. Each tumbler has a handle extending upward and a locking member extending downward for selective engagement with transverse channels in the bolt. When the bolt is disengaged, the top plate can be removed and the tumblers can be changed or exchanged so as to change the combination. The lock may be modified to include any number of tumblers in multiple rows such that the combination may be very large.

### FIELD OF THE INVENTION

This invention relates in general to locks, and more specifically involves a binary sliding tumbler lock.

### SUMMARY OF THE INVENTION

The invention is a low-profile, binary, sliding tumbler lock. The lock can be made very simply with few parts. The combination may be easily set by a user. The lock can have a simple combination such that it easily and quickly opened, even in the dark. Or the lock can have a complex combination.

The lock generally comprises a stationary case or frame including a bottom plate, a middle plate and a top plate, a plurality of laterally sliding binary tumblers, and a longitudinally sliding bolt. The top plate includes a plurality of transverse apertures. The middle plate includes a downward facing surface spaced above the bottom plate and a top surface having a plurality of transverse slots therein. The bolt includes a body sliding between the bottom plate and the downward facing surface of the middle plate. The top of the bolt has a plurality of transverse channels.

The tumblers have a bearing portion for lateral sliding movement sandwiched between the top plate and the middle plate. Each tumbler has a handle extending upward from the bearing portion and through the transverse apertures of the top plate for manipulation by a user. Each tumbler has a slot bearing portion downwardly extending from the bearing portion for sliding in a transverse slot of the middle plate and a locking member extending lower than the slot for selective engagement with the transverse channels in the bolt.

Each tumbler is laterally slideable between an engaged position wherein its locking member is engaged in a bolt channel and a disengaged position wherein its locking member is not engaged. The bolt has a locked position when at least one locking member is engaged such that the bolt cannot slide longitudinally. The bolt is longitudinally slideable between the locking position and a free position when no locking members are engaged with the bolt channels. The positions of the tumblers when all are disengaged define the combination to the lock.

In a preferred embodiment, when the bolt is disengaged, the top plate can be removed and the tumblers can be changed or exchanged so as to change the combination.

The lock may be modified to include any number of tumblers in multiple rows such that the combination may be very large.

Other features and many attendant advantages of the invention will become more apparent upon a reading of the following detailed description together with the drawings wherein like reference numerals refer to like parts throughout.

### BRIEF DESCRIPTION OF THE DRAWINGS

FIG. 1 is a top, front, left perspective view of a first exemplary embodiment of the lock of the invention in a locked position.

FIG. 2 is an exploded perspective view of the lock of FIG. 1 in an unlocked position.

FIG. 3 is an exploded left side view of the lock of FIG. 2 without the tumbler knobs.

FIG. 4 is a top plan view of a 0 tumbler.

FIG. 5 is a front elevation view of the 0 tumbler if FIG. 4.

FIG. 6 is a left side elevation view of the 0 tumbler of FIG. 4.

FIG. 7 is a top plan view of a 1 tumbler.

FIG. 8 is a front elevation view of the 1 tumbler of FIG. 7.

FIG. 9 is a left side elevation view of the 1 tumbler of FIG. 7.

FIG. 10 is a sectional view taken on line 10-10 of FIG. 3 but with the elements assembled.

FIG. 11 is a sectional view taken on line 11-11 of FIG. 3 but with the elements assembled.

FIG. 12 is a sectional view taken on line 12-12 of FIG. 3 but with the elements assembled.

FIG. 13 is a lateral cross sectional view of a tumbler detent.

FIG. 14 is a top, front, left perspective view of an alternate exemplary embodiment of the lock of the invention shown in use with a gate.

FIG. 15 is an exploded perspective view of the lock of FIG. 13.

### DETAILED DESCRIPTION OF THE INVENTION

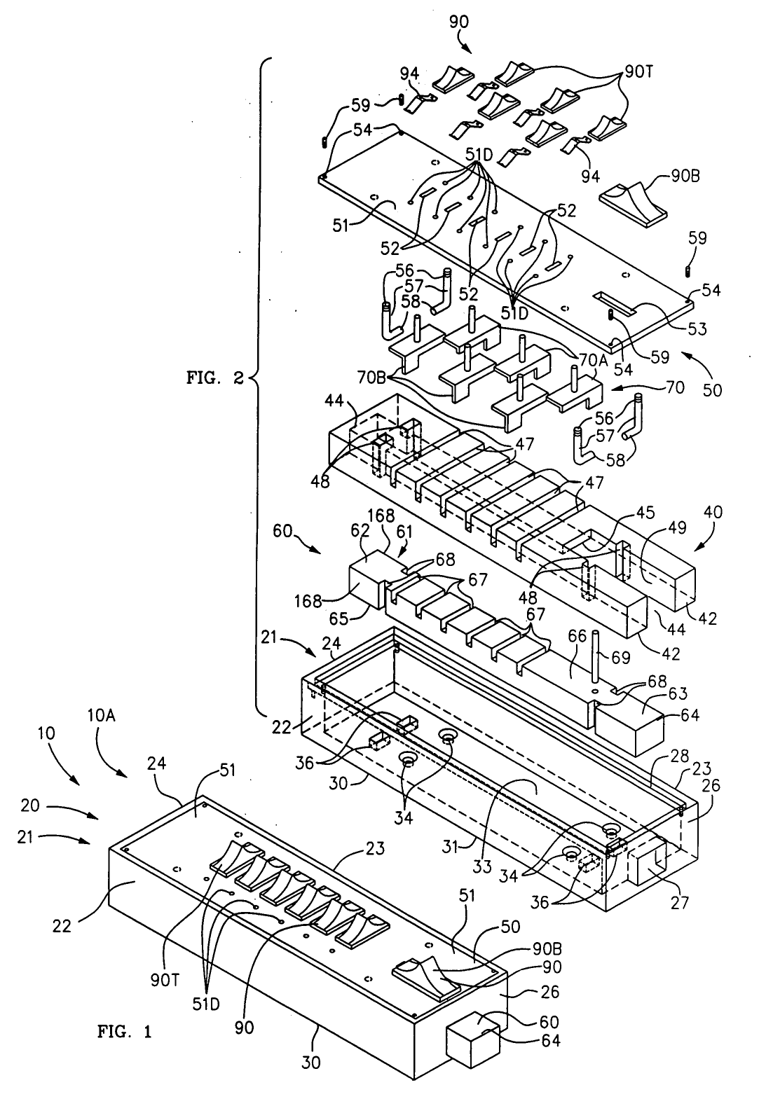

With reference now to the drawings, FIG. 1 is a top, front, left perspective view of a first exemplary embodiment, single bar lock 10A, of lock 10 of the invention shown in the locked position. Lock 10A includes a case or frame 20 housing most of the lock elements. Frame 20 includes side or vertical walls 21 including left and right side walls 22, 23, rear wall 24, and front wall 26, bottom plate 30, and top plate 50 to form an enclosure. The tongue 64 of bolt 60 protrudes from frame 20 in the locked position. Knobs 90, such as tumbler knobs 90T and bolt knob 90B are manipulated by the user.

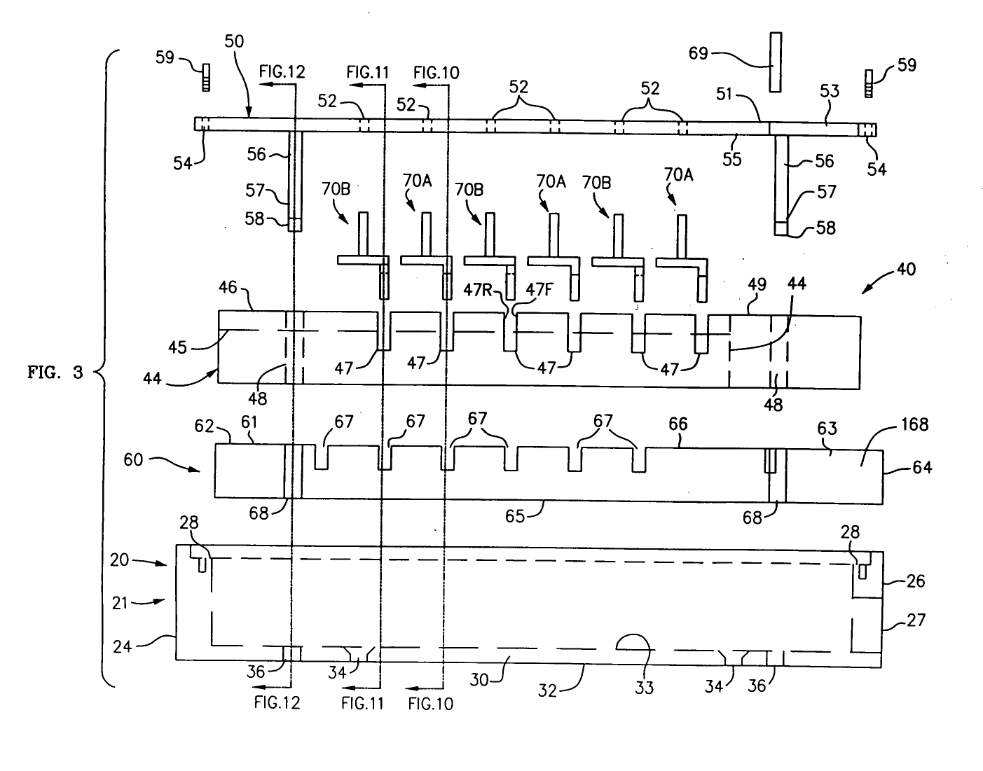

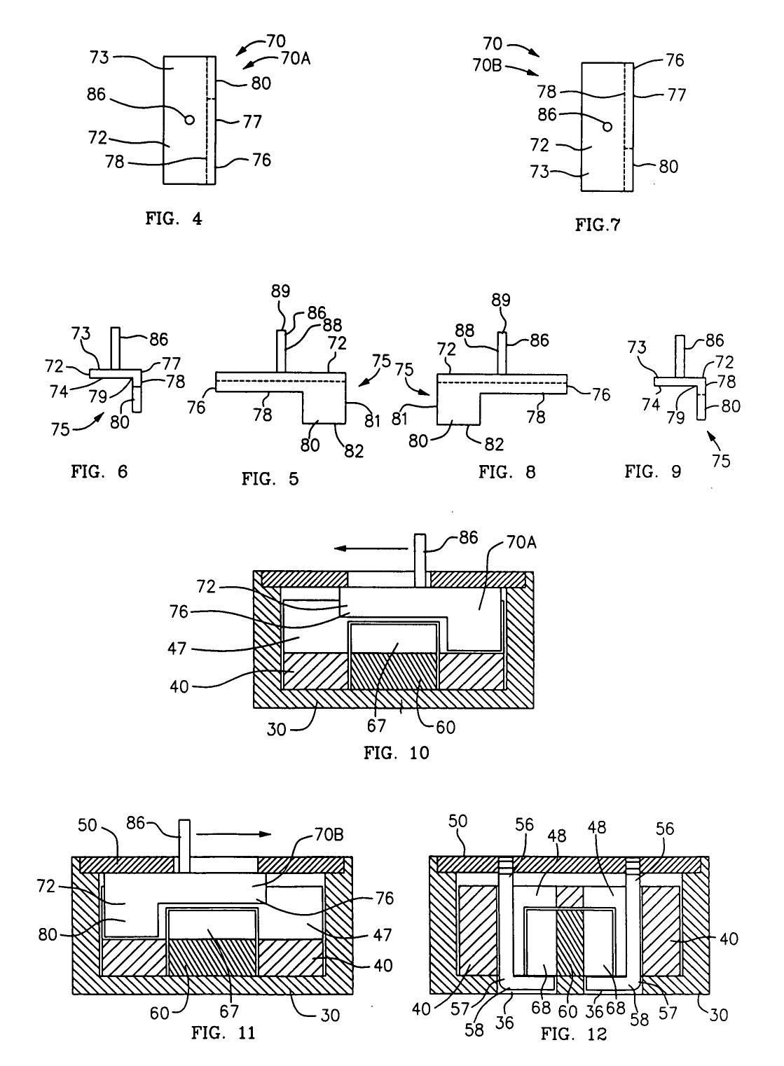

Looking further at FIGS. 2-4, FIG. 2 is an exploded perspective view of lock 10A of FIG. 1 in an unlocked position; FIG. 3 is an exploded left side view of lock 10A of FIG. 2, FIG. 4 is a front elevation view of lock 10A of FIG. 2, and FIG. 5 is a rear elevation view thereof.

Top plate 50 has a top surface 51, a bottom surface 55, and a plurality of downward projecting release legs 56, each including a bottom end 57 including a horizontally projecting foot 58. Top plate 50 has a plurality of transverse apertures 52 therethrough and a longitudinal aperture 53 therethrough. Selective attachment means, such as a plurality of bores 54 receiving fasteners, such a machine screws 59, is provided to selectively attach top plate 50 to the remainder of frame 20.

Bottom plate 30 has a bottom surface 31 and a generally planar top surface 33. Bottom plate 30 includes mounting means, such as bores 34 therethrough, for receiving fasteners, for mounting frame 20. Recesses in or bores 36 through bottom plate 30 receive the bottom ends 57 of release legs 56. Front wall 26 includes an orifice 27 therethrough for sliding passage of the tongue 64 of bolt 60 to the locking position. Vertical walls 21 have a lip 28 on the inside of their upper ends for receiving top plate 50 in a recessed position. Vertical walls 21 and bottom plate 30 may be connected to one another in any of several manners, such as being integral or by welding, as is known in the art.

Frame 20 further includes a middle plate 40 surrounded by walls 21 and spaced between top plate 50 and bottom plate 30. Middle plate 40 is stationary and may be sized to fit between walls 21 such that it cannot move horizontally, as shown, or may be otherwise attached to frame 20, such as by welding. In the exemplary embodiment, middle plate 40 has side portions 42, resting on bottom plate 30 and extending between front and rear walls 24, 26, and a central tunnel 44 having a downward facing surface 45 spaced above top surface 33 of bottom plate 30. Middle plate 40 has a top surface 46 spaced below bottom surface 55 of top plate 50. A plurality of transverse slots 47 extend downward from top surface 46. Each transverse slot 47 has a front wall 47F and a rear wall 47R.

Vertical passageways 48 in middle plate 40 provide for passage of release legs 56 from top plate 50. A vertical orifice 49 in the front end of middle plate 40 provides for movement of bolt handle 69, as will later be explained.

Bolt 60 is an elongate rod having a body 61 including a rear end 62, a front end 63 terminating in a locking tongue 64, a plurality of vertical orifices 68, a bottom surface 65 bearing against top surface 33 of bottom plate 30, a top surface 66 bearing against downward facing surface 45 of middle plate 40, and a plurality of transverse channels 67 extending downward from top surface 66. An upward projecting handle 69 connected to body 61 includes a midsection extending upwards through a longitudinal aperture 53 in top plate 50 and a top end for longitudinal sliding manipulation of bolt 60 by a user. A removable knob 90B is attached, such as with a friction fit to top end of handle 69, for easier manipulation by a user. In the unlocked position, bolt 60 is longitudinally slideable.

Vertical orifices 68 pass through the side walls 168 of bolt 60 and provide for vertical passage of horizontally projecting foot 58 of release legs 56 of top plate 50 when bolt 60 is in an unlocked position.

Although, bolt 60 is shown and described as having a tongue 64 for directly engaging a receiver, the bolt need not have such as tongue 64. Instead, bolt 60 could transfer movement via a connecting rod, such as through a slot or other orifice in bottom plate 30 to another bolt or engaging mechanism. For example, a door could contain an internal sliding bolt having a tongue of engaging a receiver in a door jam. Lock 10A could be attached to the front face of the door and a rod attached to both lock bolt 60 and the door bolt and passing through a slot in bottom plate 30 could connect the bolts for activating the door bolt.

A plurality of sliding tumblers 70 activates lock 10. Further looking at FIGS. 4-9, FIG. 4 is a top plan view of a “0” tumbler 70A, FIG. 5 is a front elevation view thereof, and FIG. 6 is a left side elevation view thereof. FIG. 7 is a top plan view of a “1” tumbler 70B, FIG. 8 is a front elevation view thereof, and FIG. 9 is a left side elevation view thereof. Tumblers 70 can be slide to the right or to the left to end positions. A 0 tumbler 60A is disengaged from bolt 60 in the right position. A 1 tumbler 70B is disengaged from bolt 60 in the left position. The positions of all tumblers 70 in their disengaged position defines the combination of lock 10.

Each tumbler 70 generally includes a first or horizontal bearing portion 72, a downwardly extending member 75, and a handle 86.

Horizontal bearing portion 72 includes a top surface 73 bearing against bottom surface 55 of top plate 50, and a bottom surface 74 bearing against top surface 46 of middle plate 40. Horizontal bearing portion 72 is sandwiched snugly between these surfaces 55, 46 such that tumbler 70 may slide transversely but not move vertically or tilt. Preferably, the lateral length of horizontal bearing portion 72 is sufficient such that its lateral ends are not seen through transverse apertures 52 in top plate 50 when tumbler 70 is moved and tumbler 70 completely covers the bottom of transverse apertures 52 at all times.

Downwardly extending member 75 generally includes a slot bearing portion 76 and a locking member 80. Slot bearing portion 76 includes a top end 77 attached to horizontal bearing portion 72, a front face 78 bearing against front wall 47F of transverse slot 47 in middle plate 40, and a rear face 79 bearing against rear wall 47R of transverse slot 47 in middle plate 40 such that tumbler 70 can not rotate about a vertical axis.

Locking member 80 includes a top end 81 attached to slot bearing portion 76 and a bottom end 82 extending below downward facing surface 45 of middle plate 40.

Handle 86 is attached to horizontal bearing portion 72 and includes a midsection 88 extending upwards through transverse aperture 52 in top plate 50 and a top end 89 for lateral sliding manipulation of tumbler 70 by a user. A removable knob 90T is attached, such as with a friction fit, top end 89.

FIG. 10 is a sectional view taken on line 10-10 of FIG. 3 of the elements assembled showing a 0 tumbler 70A in the disengaged position. It can be seen that moving 0 tumbler 70A to the right by use of handle 86 moves locking member 80 to the engaged position in transverse channel 67 of bolt 60.

FIG. 11 is a sectional view taken on line 11-11 of FIG. 3 of the elements assembled showing a 1 tumbler 70B in the disengaged position. It can be seen that moving 1 tumbler 70B to the left by use of handle 86 moves locking member 80 to the engaged position in slot 67 of bolt 60.

Each bolt channel 67 is adapted for receiving a locking member 80 of a tumbler 70 such that locking member 80 may slide in channel 67. Each tumbler 70 is laterally slideable between an engaged position wherein its locking member 80 is engaged in a channel 67 and a disengaged position wherein its locking member 80 is not engaged in channel 67 but is off to side of bolt 60 such as toward the end of slot 47 in middle plate 40. Bolt 60 has a locked position when at least one locking member 80 is engaged in a channel 67 such that bolt 60 cannot slide longitudinally. Bolt is longitudinally slideable between the locking position and a free position when no locking members are engaged with channels 67. The positions of tumblers 70 when all are disengaged define the combination to lock 10. Each tumbler 70 is engaged with full lateral movement in one direction and disengaged with full lateral movement in the opposite direction. Designating the left position of a tumbler 70 as “1” and the right position of a tumbler 70 as “1”, it can be seen that the combination of lock 10A as shown in FIGS. 2 and 3 is 101010.

FIG. 12 is a sectional view taken on line 12-12 of FIG. 3 of the elements assembled showing how lock 10 is easily disassembled to change the combination. When bolt 60 is in the locking position, feet 58 of release legs 56 of top plate 50 are disposed under bolt 60 that top plate 50 cannot be raised. Lock 10 is disassembled by removing Allen head machine screws 59, the selective retaining means accessible to a user for selectively retaining top plate 50 to the remainder of frame 20 independent of bolt position. Then tumblers 70 are moved to the combination. When bolt 60 is in the free position, feet 59 of release legs 56 of top plate 50 are alignable with vertical orifices 68 in bolt 60 and any foot portion of passageways 48 for legs 56 in middle plate 40 such that foot 58 can move upward such that top plate 50 can be raised. With top plate 50 raised, tumblers 70 are accessible such that the combination to the lock can be changed by exchanging tumblers 70A and 70B within the group to arrive at another combination having 3 0s and 3 1s. Or spare 0 and 1 tumblers 70A, 70B could be substituted for any current tumblers 70 to achieve any possible combination.

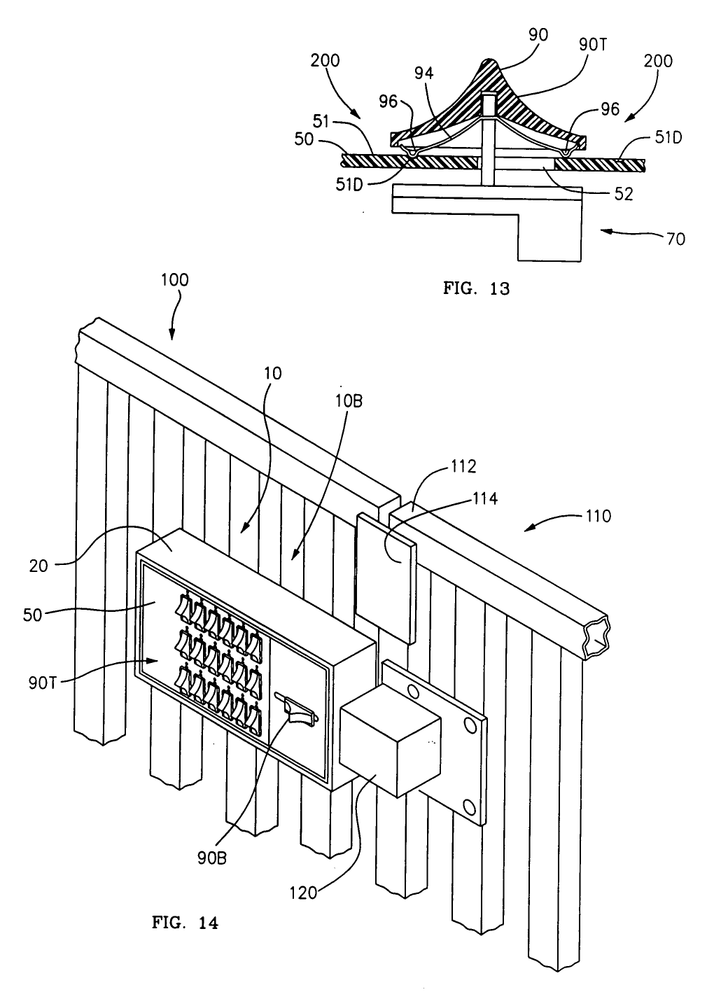

Tumblers 70 are provided with a detent means 200 for retaining tumblers 70 in either the engaged or disengaged position. FIG. 13 is a lateral cross sectional view of an exemplary detent means 200 for tumblers 70. Frame 20, such as top plate 50, and tumbler 70, such as knob 90, include cooperating detent means 100. Knob 90 includes a resilient member 94 including protuberances 96 for engaging dimples 51D in top surface 51 of top plate 50. Other tumbler detent means 200 are contemplated. For example, resilient restrictions in each transverse aperture 52 near its ends for restrictive passage of tumbler handle 86 could be used.

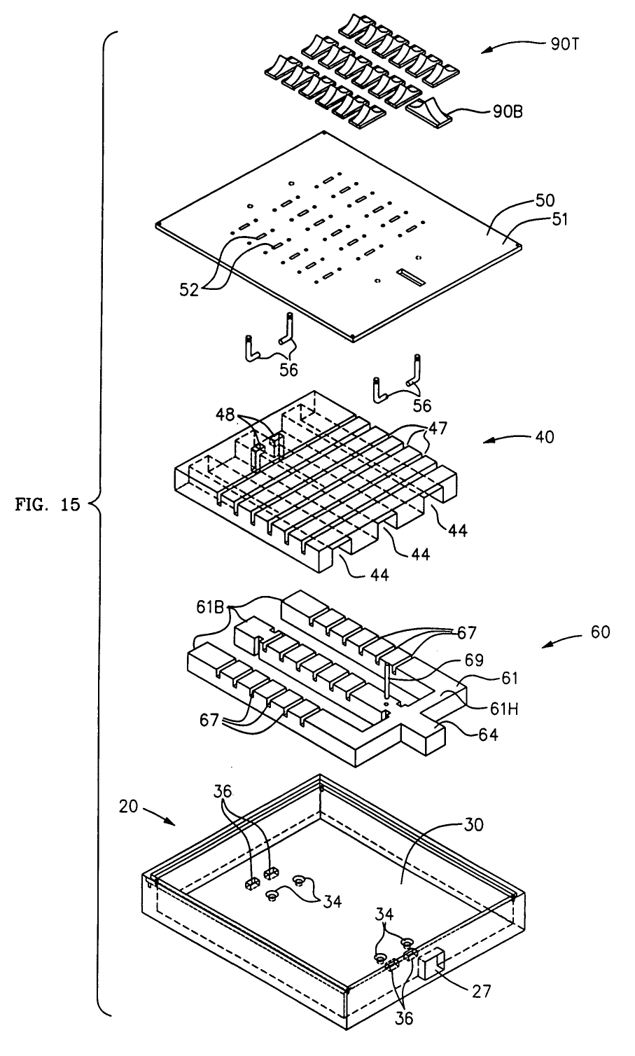

FIG. 14 is a top, front, left perspective view of an alternate exemplary embodiment, multiple bar lock 10B, of lock 10 of the invention shown in use mounted on a wall or fence 100 for controlling a gate 110 in fence 100. FIG. 15 is an exploded perspective view of lock 10B of FIG. 14. Multiple bar lock 10B is similar to lock 10A and is included to show the ease in expanding the number of possible combinations by including multiple rows of tumblers 70.

Gate 110 includes a hinged end, not shown, and free end 112 including a stop 114 for aligning gate 110 or free end 112 with the remainder of fence 100 when gate 110 is closed. A bolt receiver 120 is mounted on free end 112 of gate 110 for receiving tongue 64 of bolt 60 for locking gate 110 as known in the art. Except as noted, lock 10B includes the elements of lock 10A.

Top plate 50 includes multiple, such as three, rows of a plurality, in this case six, transverse apertures 52. This provides for 18 tumblers, not shown, or 2 to the 18^{th} power of combination or 262,144 combinations.

Bolt 60 includes a body 61 including a plurality of bars 61B and connecting means, such as header 61H, connecting bars 61B in spaced, parallel relationship. Each bar 61B includes a plurality of transverse channels 67 for receiving locking members 67 of tumblers 70. Although, header 61H is shown connecting bars 61B toward their front end, a footer or other connector could be used to connect bars 61B at other positions on bars 61B.

Middle plate 40 includes three tunnels 44, each for receiving a bar 61B. Lock 10B functions in the same manner as lock 10A except that, in lock 10B all bars 61B need to be disengaged from tumblers 70 for the bolt 60 to slide.

From the foregoing description, it is seen that the present invention provides an extremely simple, efficient, and reliable lock. The small number and simplicity of the parts should be appreciated. A lock with few tumblers 70, such as lock 10A, may be effectively used where a thief or other person, such as child, doesn't have time, knowledge, or patience to pick the lock. A lock with many tumblers 70, such as lock 10B, may be used when greater resistance to picking is desired. The user may adjust lock 10 to so as to be quickly and easily opened, such as by moving as only a few tumblers 70 or by moving only one tumbler 70. This may be done, for examples, by presetting all of the other tumblers 70 to their disengaged positions or by having all the other tumblers 70 be one kind of tumbler 70 and the few tumblers to be moved the opposite kind of tumbler 70. Thus, lock 10 may be quickly opened, even in the dark, for access such as to a gun or other weapon.

Although a particular embodiment of the invention has been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

I claim:

1. A low profile, sliding tumbler lock comprising:
a stationary frame including
a bottom plate including:
a top surface;
a middle plate including:
a downward facing surface spaced above said top surface of said bottom plate;
a top surface; and
a plurality of transverse slots in said top surface, each including:
a front wall; and
a rear wall:
a top plate including:
a bottom surface spaced above said top surface of said middle plate; and
a plurality of transverse apertures;
a plurality of sliding tumblers; each tumbler including:
a bearing portion including:
a top surface bearing against said bottom surface of said top plate; and
a bottom surface bearing against said top surface of said middle plate; said bearing portion sandwiched snugly between said bottom surface of said top plate and said upward bearing surface of said middle plate such that said tumbler may slide transversely and not move vertically;
a downwardly extending member including:
a slot bearing portion including:
a top end attached to said first bearing portion;
a front face bearing against said front wall of said transverse slot in said middle plate; and
a rear face bearing against said rear wall of said transverse slot in said middle plate such that said tumbler can not rotate about a vertical axis; and
a locking member 80 including:
a top end attached to said slot bearing portion; and
a bottom end extending below said downward facing surface of said middle plate; and
a handle including:
a midsection extending upwards through said transverse aperture in said top plate; and
a top end for lateral sliding manipulation of said tumbler by a user; and
a bolt including:
a body including:
a bottom surface bearing against said top surface of said bottom plate; and
a top surface bearing against said downward facing surface of said middle plate including:
a plurality of transverse channels; and
a handle connected to said body for sliding manipulation of said bolt by a user; wherein: each said channel is adapted for receiving one said bottom end of one said tumbler such that said bottom end may slide in said channel; each said tumbler is laterally slideable between an engaged position wherein its said locking member is engaged in one said channel and a disengaged position wherein said locking member is not engaged in one said channel; said bolt has a locked position when at least one said locking member is engaged in one said channel such that said bolt cannot slide longitudinally; and said bolt is longitudinally slideable between the locking position and a free position when no said locking members are engaged with said channels.

2. The lock of claim 1 wherein:
said tumblers and said frame include:
cooperating detent means for retaining said tumblers in either the engaged or disengaged position.

3. The lock of claim 1 wherein:
each said tumbler is engaged with full lateral movement in one direction and disengaged with full lateral movement in the opposite direction

4. The lock of claim 1 wherein:
said top plate includes:
a longitudinal aperture; and
said handle of said bolt includes:
a midsection extending upwards through said longitudinal aperture in said top plate; and
a top end for longitudinal sliding manipulation of said bolt by a user.

5. A low profile, sliding tumbler lock comprising:
a stationary frame including
a bottom plate including:
a top surface;
a middle plate including:
a downward facing surface spaced above said top surface of said bottom plate;
a top surface; and
a plurality of transverse slots in said top surface; and
a top plate including:
a bottom surface spaced above said top surface of said middle plate;
a plurality of transverse apertures; and
a downward projecting leg including:
a bottom end including:
a foot;
a plurality of sliding tumblers; each tumbler including:
a bearing portion including:
a top surface bearing against said bottom surface of said top plate; and
a bottom surface bearing against said top surface of said middle plate; said bearing portion sandwiched snugly between said bottom surface of said top plate and said upward bearing surface of said middle plate such that said tumbler may slide transversely and not move vertically;
a downwardly extending member including:
a slot bearing portion including:
a top end attached to said first bearing portion;
a front face bearing against said front wall of said transverse slot in said middle plate; and
a rear face bearing against said rear wall of said transverse slot in said middle plate such that said tumbler can not rotate about a vertical axis; and
a locking member 80 including:
a top end attached to said slot bearing portion; and
a bottom end extending below said downward facing surface of said middle plate; and
an upwardly extending handle including:
a midsection extending upwards through a transverse aperture in said top plate; and
a top end for lateral sliding manipulation of said tumbler by a user; and
a bolt including:
a body including:
a vertical orifice;
a bottom surface bearing against said top surface of said bottom plate; and
a top surface bearing against said downward facing surface of said middle plate including:
a plurality of transverse channels; and
a handle connected to said body for sliding manipulation of said bolt by a user; wherein: each said channel is adapted for receiving one said bottom end of one said tumbler such that said bottom end may slide in said channel; each said tumbler is laterally slideable between an engaged position wherein its said locking member is engaged in one said channel and a disengaged position wherein said locking member is not engaged in one said channel; said bolt has a locked position when at least one said locking member is engaged in one said channel such that said bolt cannot slide longitudinally; and said bolt is longitudinally slideable between the locking position and a free position when no said locking members are engaged with said channels; the positions of said tumblers when all are disengaged define the combination to said lock; said foot is disposed under said bolt in the locking position such that said top plate cannot be raised; and said foot is alignable with said vertical orifice when said bolt is in the free position such that said foot can move upward in said vertical orifice such that said top plate can be raised such that said tumblers are accessible such that the combination to the lock can be changed.

6. The lock of claim 5 wherein:
said tumblers and said frame include:
cooperating detent means for retaining said tumblers in either the engaged or disengaged position.

7. The lock of claim 5 wherein:
each said tumbler is engaged with full lateral movement in one direction and disengaged with full lateral movement in the opposite direction.

8. The lock of claim 5 wherein:
said top plate includes:
a longitudinal aperture; and
said handle of said bolt includes:
a midsection extending upwards through said longitudinal aperture in said top plate; and
a top end for longitudinal sliding manipulation of said bolt by a user.

9. The lock of claim 5 further including:
selective retaining means accessible to a user for selectively retaining said top plate to the remainder of said frame independent of bolt position.

10. A low profile sliding tumbler lock comprising:
a stationary frame including
a bottom plate including:
a top surface;
a middle plate including:
a downward facing surface spaced above said top surface of said bottom plate;
a top surface; and
a plurality of transverse slots in said top surface; and
a top plate including:
a bottom surface spaced above said top surface of said middle plate; and
a plurality of transverse apertures;
a plurality of sliding tumblers; each tumbler including:
a bearing portion including:
a top surface bearing against said bottom surface of said top plate; and
a bottom surface bearing against said top surface of said middle plate; said bearing portion sandwiched snugly between said bottom surface of said top plate and said upward bearing surface of said middle plate such that said tumbler may slide transversely and not move vertically;
a downwardly extending member including:
a slot bearing portion including:
a top end attached to said first bearing portion;
a front face bearing against said front wall of said transverse slot in said middle plate; and
a rear face bearing against said rear wall of said transverse slot in said middle plate such that said tumbler can not rotate about a vertical axis; and
a locking member 80 including:
a top end attached to said slot bearing portion; and
a bottom end extending below said downward facing surface of said middle plate; and
an upwardly extending handle including:
a midsection extending upwards through a transverse aperture in said top plate; and
a top end for lateral sliding manipulation of said tumbler by a user; and
a bolt including:
a body including:
connecting means;
a plurality of bars connected to said connecting means in spaced, parallel relationship; each bar including:
a bottom surface bearing against said top surface of said bottom plate; and
a top surface bearing against said downward facing surface of said middle plate including:
a plurality of transverse channels; and
a handle connected to said body for sliding manipulation of said bolt by a user; wherein: each said channel is adapted for receiving one said bottom end of one said tumbler such that said bottom end may slide in said channel; each said tumbler is laterally slideable between an engaged position wherein its said locking member is engaged in one said channel and a disengaged position wherein said locking member is not engaged in one said channel; said bolt has a locked position when at least one said locking member is engaged in one said channel such that said bolt cannot slide longitudinally; and said bolt is longitudinally slideable between the locking position and a free position when no said locking members are engaged with said channels.

11. The lock of claim 10 wherein:
a top plate includes:
a downward projecting leg including:
a bottom end including:
a foot; and
said body of said bolt includes:
a vertical orifice; wherein: the positions of said tumblers when all are disengaged define the combination to said lock; said foot is disposed under said bolt in the locking position such that said top plate cannot be raised; and said foot is alignable with said vertical orifice when said bolt is in the free position such that said foot can move upward in said vertical orifice such that said top plate can be raised such that said tumblers are accessible such that the combination to the lock can be changed.

12. The lock of claim 11 further including:
selective retaining means accessible to a user for selectively retaining said top plate to the remainder of said frame independent of bolt position.

13. The lock of claim 10 wherein:
said tumblers and said frame include:
cooperating detent means for retaining said tumblers in either the engaged or disengaged position.

14. The lock of claim 10 wherein:
each said tumbler is engaged with full lateral movement in one direction and disengaged with full lateral movement in the opposite direction.

15. The lock of claim 10 wherein:
said top plate includes:
a longitudinal aperture; and
said handle of said bolt includes:
a midsection extending upwards through said longitudinal aperture in said top plate; and
a top end for longitudinal sliding manipulation of said bolt by a user.
